(19) United States
(12) Patent Application Publication
(10) Pub. No.: US 2014/0283364 A1
(43) Pub. Date: Sep. 25, 2014

(54) Golf Club Head Alloy and Method for Producing a Sheet Material for a Striking Plate of a Golf Club Head by Using the Same

(71) Applicant: FUSHENG PRECISION CO., LTD., Taipei City (TW)

(72) Inventors: Ming-Jui Chiang, Taipei City (TW); Chun-Fu Chang, Taipei City (TW)

(21) Appl. No.: 13/946,021

(22) Filed: Jul. 19, 2013

(30) Foreign Application Priority Data
Mar. 21, 2013 (CN) 201310091034.1

(51) Int. Cl. A63B 53/04; C22C 14/00; B23P 15/00

(52) U.S. Cl. CPC A63B 53/04; B23P 15/00; C22C 14/00
USPC 29/527.1; 420/420

(57) ABSTRACT

A golf club head alloy includes 7-9.5 wt % of aluminum, 0.5-2 wt % of vanadium, 0.05-0.4 wt % of silicon, less than 0.4 wt % of iron, less than 0.15 wt % of oxygen, less than 0.1 wt % of carbon, less than 0.05 wt % of nitrogen, with the rest being titanium. The golf club head alloy has a density of 4.32-4.35 g/cm³. A method uses the golf club head alloy to produce a sheet material for a club head striking plate. The method includes smelting the golf club head alloy into a titanium alloy rod, and repeatedly heating the titanium alloy rod and forging the titanium alloy rod into a flat blank. The flat blank is hot rolled to form a thin blank, wherein the flat blank has a reduction ratio of 70-75%. The thin blank is cold rolled into an alloy sheet material, and the alloy sheet material is annealed to form a sheet material for a club head striking plate.

### BACKGROUND OF THE INVENTION

1. Field of the Invention

The present invention relates to a golf club head alloy and a method for producing a sheet material for a striking plate of a golf club head by using the golf club head alloy and, more particularly, to a low-density, high-toughness golf club head alloy and a method for producing a durable sheet material for a striking plate of a golf club head by using the golf club head alloy.

2. Description of the Related Art

Conventionally, the parts of a golf club head, such as the club head body, the striking plate, the lid or the weights, are generally produced through precision casting of stainless steel, such as SUS630 or SUS431 (type 630 or type 431 according to American Iron and Steel Institute). However, due to the high density and low strength of stainless steel, the parts of the golf club head must exceed a certain thickness to meet the strength requirements of the club head, leading to a reduction in the tolerance in adjustment of the position of the center of the golf club head. As a result, the striking effect of the resultant golf club head is unsatisfactory.

To allow adjustment of the position of the center of the golf club head for obtaining a better hitting effect, manufacturers often focus on production of the striking plate. Specifically, the weight saved from the striking plate is dispatched on the remaining portions of the club head to shift the center of the golf club head to an appropriate location.

As for metal materials, since the densities of titanium alloys are smaller than the density of the stainless steel and since the strengths of titanium alloys are substantially the same as the strength of stainless steel, titanium alloys possess better elastic deforming characteristics. Thus, titanium alloys, such as Ti-6Al-4V including 6 wt % of aluminum and 4 wt % of vanadium, are used to produce the striking plate of a golf club head for controlling the weight of the club head for the purposes of adjusting the position of the center of the club head. Furthermore, the elastic deforming characteristics of the titanium alloys can reduce the compression deformation of the golf ball hit by the striking plate, increasing the hitting distance by reducing the energy loss through reduced striking stress.

However, the mechanical properties, such as the strength, ductility and toughness, of the striking plate of the golf club head serving as the force-receiving face for direct contact with the golf ball must be sufficiently large. Taking Ti-6Al-4V as an example, although it can be used to produce a striking plate with a reduced thickness meeting the characteristic time (CT) of international standards for increasing the hitting distance, the reduced thickness of the striking plate adversely affect the cannon test results. Specifically, the impact toughness of the striking plate with a reduced thickness is not satisfactory such that the striking plate is liable to fatigue.

Thus, a need exists for a low-density golf club head alloy for producing a durable sheet material for a striking plate of a golf club head to mitigate and/or obviate the above disadvantages.

### SUMMARY OF THE INVENTION

The primary objective of the present invention is to provide a golf club head alloy having a high strength and a low density to mitigate and/or obviate the above disadvantages.

The secondary objective of the present invention is to provide a method for producing a sheet material for a striking plate of a golf club head. The sheet material possesses enhanced toughness to resist impact and is light, increasing the hitting effect of the striking plate made from the sheet material and prolonging the service life of the striking plate.

The present invention fulfills the above objectives by providing, in a first aspect, a golf club head alloy including 7-9.5 wt % of aluminum, 0.5-2 wt % of vanadium, 0.05-0.4 wt % of silicon, less than 0.4 wt % of iron, less than 0.15 wt % of oxygen, less than 0.1 wt % of carbon, less than 0.05 wt % of nitrogen, the rest being titanium. The golf club head alloy has a density of 4.32-4.35 g/cm³.

Preferably, the golf club head alloy includes 7.5-8.5 wt % of aluminum, 1.0-1.5 wt % of vanadium, 0.15-0.25 wt % of silicon, 0.25-0.4 wt % of iron, less than 0.15 wt % of oxygen, less than 0.1 wt % of carbon, less than 0.05 wt % of nitrogen, the rest being titanium, and the density of the golf club head alloy is 4.33 g/cm³.

In a second aspect, a method according to the present invention includes using the golf club head alloy to produce a sheet material for a striking plate of a golf club head. The method includes smelting the golf club head alloy into a titanium alloy rod, and repeatedly heating the titanium alloy rod at 890-1200° C. and forging the titanium alloy rod into a flat blank. A first hot rolling is conducted on the flat blank to compress and thin the flat blank at a temperature above 850° C., and a second hot rolling is conducted on the flat blank to form a thin blank, wherein the flat blank has a reduction ratio of 70-75%. The thin blank is cold rolled into an alloy sheet material having a thickness of 1-5 mm, and the alloy sheet material is annealed to form a sheet material for a striking plate of a golf club head.

Preferably, the titanium alloy rod is heated to 1150° C. during forging, and the titanium is heated and forged two to four times to form the flat blank.

Preferably, the first hot rolling is conducted at 1020° C., and the reduction ratio of the flat blank is 73%. The second hot rolling is conducted at 1020° C. after the first hot rolling, and the reduction ratio of the flat blank is 75%.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a view illustrating plastic deformation of a sheet material according to the present invention and a conventional sheet material during elongation.

FIG. 2 is a diagram illustrating the difference between the characteristic time (CT) of the sheet material the according to the present invention and the characteristic time (CT) of the conventional sheet material.

FIG. 3 is a diagram illustrating cannon test results of the sheet material according to the present invention and the conventional sheet material.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

A golf club head alloy according to the present invention can be used to produce various parts of a golf club, preferably the string plate of a golf club head. The composition of the golf club head alloy and the method using the golf club head alloy to produce a sheet material for a striking plate of a golf club head will now be described.

The golf club head alloy includes 7-9.5 wt % of aluminum, 0.5-2 wt % of vanadium, 0.05-0.4 wt % of silicon, less than 0.4 wt % of iron, less than 0.15 wt % of oxygen, less than 0.1 wt % of carbon, less than 0.05 wt % of nitrogen, with the rest being titanium. The golf club head alloy has a density of 4.32-4.35 g/cm³.

In this example, the golf club head alloy preferably includes 7.5-8.5 wt % of aluminum, 1.0-1.5 wt % of vanadium, 0.15-0.25 wt % of silicon, 0.25-0.4 wt % of iron, less than 0.15 wt % of oxygen, less than 0.1 wt % of carbon, less than 0.05 wt % of nitrogen, and 89-91 wt % of titanium. The density of the golf club head alloy (a Ti—Al—V alloy) is 4.33 g/cm³. Through matched doping between titanium, aluminum and vanadium, the density of the golf club head alloy can be reduced while maintaining its excellent mechanical properties. The impact toughness of the golf club head alloy can be increased through addition of other elements, such as silicon, iron, oxygen and nitrogen, which is advantageous to production of various parts of a golf club head by using the alloy.

The method according to the present invention will now be described by way of example in which the above golf club head alloy is used to produce a sheet material for a striking plate of a golf club head.

The method according to the present invention includes a first step including smelting the golf club head alloy into a titanium alloy rod, and repeatedly heating the titanium alloy rod at 890-1200° C. and forging the titanium alloy rod into a flat blank. Specifically, in this example, the golf club head alloy is squeezed into a loose titanium alloy material rod by electrodes. Then, the titanium alloy material rod is placed in an arc melting furnace and heated. The titanium alloy rod is obtained after cooling the molten titanium alloy material rod. The titanium alloy rod includes 7-9.5 wt % of aluminum, 0.5-2 wt % of vanadium, 0.05-0.4 wt % of silicon, less than 0.4 wt % of iron, less than 0.15 wt % of oxygen, less than 0.1 wt % of carbon, less than 0.05 wt % of nitrogen, with the rest being titanium. Preferably, the titanium alloy rod is formed by two smelting procedures to assure a uniform composition while avoiding excessive voids, providing enhanced quality.

Specifically, the titanium alloy rod melts in a water-cooled copper crucible mold at a temperature above 1700° C. by vacuum arc and then heated and forged two to four times at a temperature below 1200° C. (preferably preheated to 1150° C.), forming a flat blank. If the heating temperature is above 1200° C., the nitrogen content and the oxygen content could be adversely affected by high-temperature oxidization during formation of the flat blank. If the forging temperature of the titanium alloy rod is lower than 890° C., the plastic deforming capability of the titanium alloy rod could be reduced, failing to form the flat blank due to the difficulties in deformation of the titanium alloy rod.

After obtaining the flat blank through the first step, a second step is carried out to hot roll the flat blank (the first hot rolling) at a temperature above 850° C. to thin the flat blank. A second hot rolling is then conducted until the flat blank has a reduction ratio of 70-75%, forming a thin blank. If the first hot rolling and the second hot rolling are carried out at a temperature below 890° C., rolling cracks may occur during hot rolling of the flat blank. Rolling crack occurs during hot rolling if the reduction ratio of the flat blank is higher than 75%. In this example, the first hot rolling is carried out at 1020° C. After the flat blank is preheated for 90 minutes, the thickness of the flat blank can be compressed from 75 mm to 20 mm. Thus, it is assured that the flat blank has a reduction ratio of about 73% after the first hot rolling. After cutting and trimming, the second hot rolling is carried out at 1020° C. The preheating is maintained 40 minutes such that the thickness of the flat blank can be compressed from 20 mm to 5.2 mm, assuring that the flat blank has a reduction ratio of not more than 75%.

In a third step, the thin blank is cold-rolled into an alloy sheet material having a thickness of 1-5 mm, and the alloy sheet material is annealed and trimmed to form a sheet material for a striking plate of a golf club head. Specifically, the thin blank can be cold-rolled to a desired thickness and treated with repeated annealing to complete production of the alloy sheet material. In this example, two cold rolling procedures are carried out to compress the thickness of the thin blank from 5.2 mm to 2-5 mm. After trimming and hot pressing, a sheet material for a striking plate of a golf club head is obtained. Namely, the sheet material can be processed to form a striking plate of a golf club head through procedures of feeding and formation.

Furthermore, pre-treatment, such as annealing, acid washing and trimming, can be carried out before the third step. In this example, annealing is carried out by a heat treatment furnace to anneal the thin blank for 50-80 minutes at 800-900° C., maintaining the processability of the thin blank. Annealing, acid washing, trimming and hot pressing used in the above steps are ordinary skills in the art.

The golf club head alloy according to the present invention can be used to produce a sheet material for a striking plate of a golf club head through the above procedures, as mentioned above. Tests were carried out to compare properties of the golf club head alloy according to the present invention and a conventional sheet material.

Table 1 shows the mechanical properties of the striking plate sheet material (hereinafter referred to as “T9S”) produced from the golf club head alloy according to the present invention, wherein the test unit of elongation is one inch. Table 2 shows the mechanical properties of the striking plate sheet material (hereinafter referred to as “T9S”) produced from the golf club head alloy according to the present invention and the conventional 6-4Ti striking plate sheet material (hereinafter referred to as “6-4Ti”), wherein the test unit of elongation is one inch.

TABLE 1

| | tensile | yield | | elon- | | |
|---|---|---|---|---|---|---|
| | strength | strength | Young's | ga- | hard- | impact |
| | MPa | MPa | Modulus | tion | ness | value |
| | (Ksi) | (Ksi) | GPa | % | HRC | Kgf × m/cm² |
| T9S | 895-1102 | 826-1033 | 100-140 | >10 | 30-40 | 2-5 |
| | (130-160) | (120-150) | | | | |

TABLE 2

| | | tensile | yield | | | | |
|---|---|---|---|---|---|---|---|
| | | strength | strength | Young's | | | impact |
| | rolling | MPa | MPa | Modulus | | hardness | value |
| | direction | (Ksi) | (Ksi) | GPa | elongation % | HRC | Kgf × m/cm² |
| T9S | longitudinal | 1047 | 971 | 110 | 23 | 36 | 3.1 |
| | direction | (152) | (141) | | | | |
| | thickness | 1019 | 950 | 123 | 19.48 | | |
| | direction | (148) | (138) | | | | |
| 6-4Ti | longitudinal | 964 | 881 | 108 | 15 | 33.5 | 2.0 |
| | direction | (140) | (128) | | | | |
| | thickness | 992 | 964 | 133 | 16.9 | | |
| | direction | (144) | (140) | | | | |

According to the mechanical property test results in both of the longitudinal direction and the thickness direction, the elongation of T9S according to the present invention is greater than the elongation of the conventional 6-4Ti by 5-10%. The difference between the tensile strength and the yield strength of T9S measured in different directions is smaller than that of the conventional 6-4Ti. Namely, the elongation during plastic deformation of T9S is more uniform. FIG. 1 shows plastic deformation of a sheet material according to the present invention (the upper one) and a conventional sheet material (the lower one) during elongation, wherein necking of the sheet material according to the present invention is less obvious than the conventional sheet material. Furthermore, the impact value of the sheet material according to the present invention is higher than that of the conventional sheet material by 55%. Namely, the striking plate made from the sheet material according to the present invention possesses enhanced impact toughness.

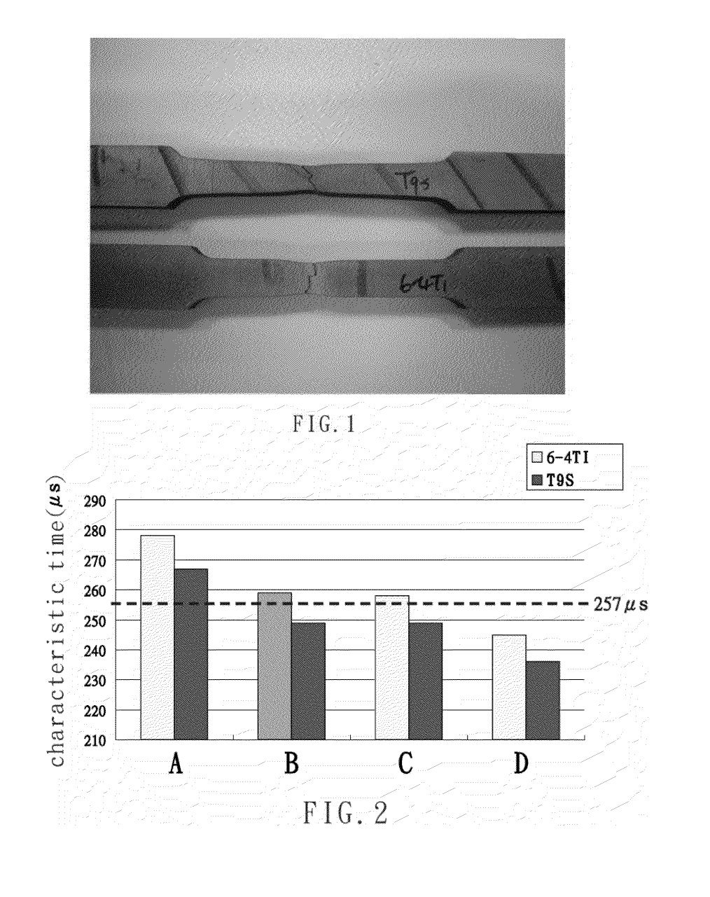

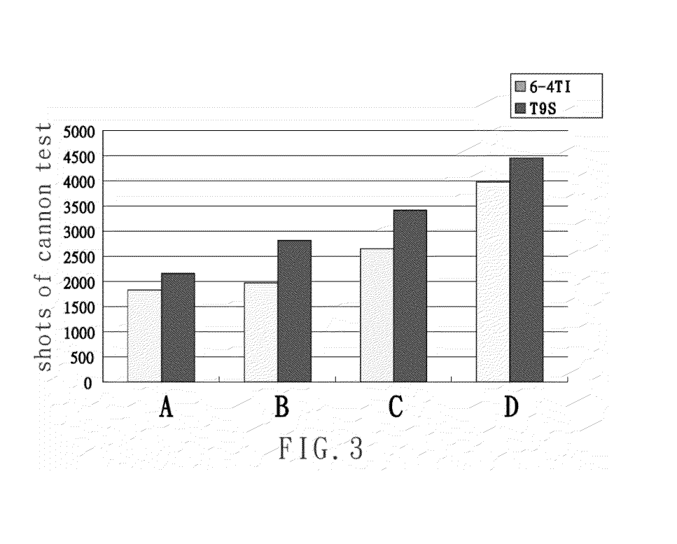

FIGS. 2 and 3 show the test results conducted on a central portion and a periphery of the striking plate of each of T9S and 6-4Ti, wherein the thickness at the central portion is different from that at the periphery. The characteristic time (CT) of the sheet material according to the present invention and the characteristic time (CT) of the conventional sheet material are shown in FIG. 2. The shots of the cannon tests on the sheet material according to the present invention and the conventional sheet material are shown in FIG. 3. The thickness at the central portion of the striking plate (the central thickness) is about 2.9-3.3 mm, and the thickness at the periphery (the peripheral thickness) of the striking plate is about 2.1-2.5 mm. Reference character A in FIGS. 2 and 3 represents striking plates (group A) having a central thickness of 2.9 mm and a peripheral thickness of 2.1 mm, and feeding was carried out in the thickness direction. Reference character B in FIGS. 2 and 3 represents striking plates (group B) having a central thickness of 3.1 mm and a peripheral thickness of 2.3 mm, and feeding was carried out in the longitudinal direction. Reference character C in FIGS. 2 and 3 represents striking plates (group C) having a central thickness of 3.1 mm and a peripheral thickness of 2.3 mm, and feeding was carried out in the thickness direction. Reference character D in FIGS. 2 and 3 represents striking plates (group D) having a central thickness of 3.3 mm and a peripheral thickness of 2.5 mm, and feeding was carried out in the thickness direction.

As can be seen from FIG. 2, although the CT of T9S is smaller than that of 6-4Ti by 7-10 μs, the striking performance of T9S still meets the international standards (CT<257 μs). With reference to FIG. 3, the shots in cannon test of T9S are higher than that of 6-4Ti. In group A, the shots of T9S are higher than the shots of 6-4Ti by about 18%. In groups B and C, the shots of T9S are higher than the shots of 6-4Ti by about 30% regardless of the feeding direction. Thus, the striking plate made from the sheet material according to the present invention possesses excellent impact toughness in comparison with the conventional sheet material.

The sheet material for a golf club head according to the present invention can be produced from the golf club head alloy having a low density and a high strength to reduce the weight of the striking plate, providing a lightweight striking plate. In this example, the weight of the striking plate made from the golf club head alloy according to the present invention is lower than the weight of the striking plate made from the conventional sheet material by about 10%. Furthermore, the striking plate made from the golf club head alloy according to the present invention possesses desired mechanical properties including strength, ductility and toughness without adverse affect by lightweighting of the striking plate. Thus, the striking plate made from the golf club head alloy according to the present invention meets the characteristic time (CT) of international standard while maintaining enhanced impact toughness, increasing the hitting performance while reducing the fatigue of the striking plate to prolong the service life of the striking plate.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A golf club head alloy comprising 7-9.5 wt % of aluminum, 0 5-2 wt % of vanadium, 0.05-0.4 wt % of silicon, less than 0.4 wt % of iron, less than 0.15 wt % of oxygen, less than 0.1 wt % of carbon, less than 0.05 wt % of nitrogen, and the rest being titanium, with the golf club head alloy having a density of 4.32-4.35 g/cm³.

2. The golf club head alloy as claimed in claim 1, wherein the golf club head alloy includes 7.5-8.5 wt % of aluminum, 1.0-1.5 wt % of vanadium, 0.15-0.25 wt % of silicon, 0-0.4 wt % of iron, less than 0.15 wt % of oxygen, less than 0.1 wt % of carbon, less than 0.05 wt % of nitrogen, with the rest being titanium, and wherein the density of the golf club head alloy is 4.33 g/cm³.

3. A method using the golf club head alloy of claim 1 to produce a sheet material for a striking plate of a golf club head, with the method comprising:
smelting the golf club head alloy into a titanium alloy rod, and repeatedly heating the titanium alloy rod at 890-1200° C. and forging the titanium alloy rod into a flat blank;
conducting a hot rolling on the flat blank to compress and thin the flat blank at a temperature above 850° C., and conducting a second hot rolling on the flat blank to form a thin blank, with the flat blank having a reduction ratio of 70-75%; and
cold rolling the thin blank into an alloy sheet material having a thickness of 1-5 mm, and annealing the alloy sheet material to form a sheet material for a striking plate of a golf club head.

4. The method as claimed in claim 3, wherein the titanium alloy rod is heated to 1150° C. during forging, and wherein the titanium is heated and forged two to four times to form the flat blank.

5. The method as claimed in claim 3, wherein the first hot rolling is conducted at 1020° C., and the reduction ratio of the flat blank is 73%, and wherein the second hot rolling is conducted at 1020° C. after the first hot rolling, and the reduction ratio of the flat blank is 75%.
